(19) United States
(12) Patent Application Publication
(10) Pub. No.: US 2024/0113338 A1
(43) Pub. Date: Apr. 4, 2024

(54) LITHIUM ION SECONDARY BATTERY

(71) Applicants: The Furukawa Battery Co., Ltd., Yokohama-shi (JP); YAMAGUCHI UNIVERSITY, Yamaguchi-shi (JP)

(72) Inventors: Yosuke Masuda, Iwaki-shi (JP); Miyu Nemoto, Iwaki-shi (JP); Hiroatsu Kondou, Iwaki-shi (JP); Koji Abe, Ube-shi, Yamaguchi (JP); Yanko Marinov Todorov, Ube-shi, Yamaguchi (JP)

(73) Assignees: The Furukawa Battery Co., Ltd., Yokohama-shi (JP); YAMAGUCHI UNIVERSITY, Yamaguchi-shi (JP)

(21) Appl. No.: 18/511,986

(22) Filed: Nov. 16, 2023

Related U.S. Application Data
(63) Continuation of application No. PCT/JP2022/020686, filed on May 18, 2022.

(30) Foreign Application Priority Data
May 19, 2021 (JP) 2021-084658
Mar. 31, 2022 (JP) 2022-058986

(51) Int. Cl. H01M 10/0568; H01M 4/36; H01M 4/505; H01M 4/525; H01M 10/0525; H01M 10/0569

(52) U.S. Cl. CPC H01M 10/0568; H01M 4/364; H01M 4/505; H01M 4/525; H01M 10/0525; H01M 10/0569; H01M 2004/027

(57) ABSTRACT

A lithium ion secondary battery includes a negative electrode including a mixture layer which contains a niobium titanium oxide as a negative electrode active material, and non-aqueous electrolyte containing lithium alkoxysulfonate represented by RSOOO⁻Li⁺ (where R is at least one selected from the group consisting of OCH₃ and OC₂H₅).

### CROSS-REFERENCE TO RELATED APPLICATION

This application is a continuation of International Application No. PCT/JP2022/020686, filed on May 18, 2022, which claims priority to and the benefit of Japanese Patent Application No. 2021-084658, filed on May 19, 2021, and Japanese Patent Application No. 2022-058986, filed on Mar. 31, 2022. The disclosures of the above applications are incorporated herein by reference.

### FIELD

The present disclosure relates to a lithium ion secondary battery.

### BACKGROUND

In recent years, lithium ion batteries with a negative electrode using a titanium oxide as a negative electrode active material, which has a higher output than conventional carbon-based negative electrodes, are commercially used. However, titanium oxides have disadvantages which are a higher electric potential with respect to metal lithium compared with carbon-based materials, a lower capacity per mass, and a lower energy density.

Therefore, monoclinic crystal system Nb—Ti based complex oxide (hereinafter, may be referred to as “TNO” or “niobium titanium oxide”), which is represented by, for example, TiNb₂O₇, are considered as the negative electrode active material. A negative electrode, which comprises a mixture layer contained TNO as a negative electrode active material, hereinafter, may be referred to as “TNO negative electrode”. The TNO negative electrode has a theoretical capacity of 387 mAh/g which is equal to that of conventional carbon-based negative electrodes, and thus, using the above material may possibly solve the problem of lower energy density found in the titanium oxide usage (cf. JP 6636758 B).

### SUMMARY

However, the TNO negative electrode exerts an electrochemical behavior which is different from that of the conventional negative electrode using titanium oxides. Thus, simple replacement of the titanium oxide with TNO cannot achieve a lithium ion secondary battery with both desired output and energy density.

Especially, the TNO negative electrode forms a solid electrolyte interface (hereinafter, may be referred to as “SEI”) film when charging, and this behavior does not appear in conventional titanium oxides. The SEI film is formed on the electrode surface of the negative electrode, causing an increase of internal resistance. Thus, a high output which is one of the significant characteristics of the lithium ion secondary battery using a titanium oxide as a negative electrode active material cannot be achieved, thereby causing a decrease in the output to prevent commercialization thereof.

Although details are not clear, niobium (Nb) in the TNO negative electrode may exert catalysis in the forming of the SEI film, and without solving this point, commercialization of a lithium ion secondary battery using the TNO negative electrode cannot be achieved. Furthermore, a material composition of the negative electrode active material and a composition of non-aqueous electrolyte relate to the forming of the SEI film, and if the non-aqueous electrolyte of the lithium ion secondary battery using a conventional titanium oxide is applied to the TNO negative electrode as is, the output thereof will be decreased.

Thus, the present application focuses on the aforementioned problem, and would present a lithium ion secondary battery which achieves both desired output and energy density.

Inventors of the present application studied non-aqueous electrolyte composition in cases where the TNO negative electrode is used to solve the above problem. Through the study performed thoughtfully, it was found that when using non-aqueous electrolyte containing a predetermined lithium alkoxysulfonate as an additive, a unique effect of the aforementioned combination is provide. As a result, the energy density of the lithium ion secondary battery can be increased to about 1.7 times that of conventional lithium titanate without significantly degrading the output characteristics of the lithium ion secondary battery. Thus, the present disclosure was completed.

In order to solve the aforementioned problem, the lithium ion secondary battery of the present disclosure includes a negative electrode which comprises a mixture layer contained a niobium titanium oxide as a negative electrode active material, and non-aqueous electrolyte containing lithium alkoxysulfonate represented by RSOOO⁻Li⁺, where R is at least one selected from the group consisting of OCH₃ and OC₂H₅.

It is preferable that the content of the lithium alkoxysulfonate in the non-aqueous electrolyte is 0.5 to 2.0 mass %.

According to an embodiment, a lithium ion secondary battery which can achieve both desired output and energy density can be presented.

Additional objects and advantages of the disclosure will be set forth in the description which follows, and in part will be obvious from the description, or may be learned by practice of the disclosure. The objects and advantages of the disclosure may be realized and obtained by means of the instrumentalities and combinations particularly pointed out hereinafter.

### DRAWINGS

The accompanying drawings, which are incorporated in and constitute a part of the specification, illustrate embodiments of the disclosure, and together with the general description given above and the detailed description of the embodiments given below, serve to explain the principles of the disclosure.

FIG. 1 is a schematic cross-sectional view of a coin battery, illustrated as an example of a lithium ion secondary battery of the present application.

FIG. 2 is a schematic cross-sectional view of a layered battery, illustrated as an example of the lithium ion secondary battery of the present application.

### DETAILED DESCRIPTION

Hereinafter, embodiments and structures of the present disclosure will be explained; however, the present disclosure is not limited thereby, and embodiments and structures conceivable within the matter recited in the scope of the disclosure, means to solve the problem, and described effects of the disclosure are encompassed by the present disclosure.

The present application relates a lithium ion secondary battery using a TNO negative electrode, and has the following two characteristics.

The first is using of a negative electrode comprising a mixture layer which contains niobium titanium oxide as a negative electrode active material. The TNO negative electrode is described in the above section, and in the present disclosure, a unique effect of the TNO negative electrode and the additive of non-aqueous electrolyte is used for solving the problem. Thus, the advantage of the present disclosure cannot be achieved even if carbon materials which are representative as negative electrode active materials of the lithium ion secondary battery are used, or even if lithium titanates are used as negative electrode active materials of the lithium ion secondary battery.

The second is using of lithium alkoxysulfonate as the additive (cf. Chemical Formula 1) in the non-aqueous electrolyte. In the present disclosure, lithium alkoxysulfonate represented in Chemical Formula 1 is used as the additive, thereby entering the additive into the SEI film to reduce the SEI film density for reducing of the internal resistance. Thus, decomposition of the lithium alkoxysulfonate itself is not intended by the present disclosure.

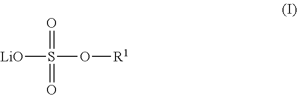

(where, R¹═CH₃, or CH₂CH₃)

Furthermore, in the present disclosure, it is preferable that the content of lithium alkoxysulfonate in the non-aqueous electrolyte is set 0.5 to 2.0 mass %. Lithium alkoxysulfonate is effective when it enters the SEI film. Thus, if the content thereof is below 0.5 mass %, the number of additive molecules entering the SEI film is also reduced. In that case, the SEI film density is not decreased, and a decrease of the internal resistance may not be obtained. On the other hand, if the content thereof is above 2.0 mass %, by solubility of lithium alkoxysulfonate with respect to the non-aqueous electrolyte, lithium alkoxysulfonate may not be fully dissolved depending on a temperature of the non-aqueous electrolyte, thereby remaining lithium alkoxysulfonate in the non-aqueous electrolyte. As a result, non-aqueous electrolyte with lithium alkoxysulfonate of a concentration higher than 2.0 mass % may not be prepared.

Furthermore, it is more preferably that the content of lithium alkoxysulfonate in the non-aqueous electrolyte is set to 1.0 to 2.0 mass %, a decrease of the internal resistance becomes sufficient, and solubility with respect to the non-aqueous electrolyte is fully secured.

(Quantitative Determination Method of Lithium Alkoxysulfonate in Non-Aqueous Electrolyte)

Note that, the content of lithium alkoxysulfonate in the non-aqueous electrolyte can be determined by, for example, preparing a calibration curve as follows, and measuring target non-aqueous electrolyte as a sample through ion chromatography.

<Preparation of Calibration Curve>

A calibration curve was prepared by arbitrarily changing the amount of lithium alkoxysulfonate.

<Quantitative Determination Method of Lithium Alkoxysulfonate>

Quantification target non-aqueous electrolyte with an unknown content of lithium alkoxysulfonate is measured by ion chromatography, and if a peak is measured in the same retaining time as the solution used for preparing the calibration curve, lithium alkoxysulfonate is contained in the non-aqueous electrolyte. Furthermore, an additive amount can be determined from a peak area by ion chromatography and the calibration curve.

[Lithium Ion Secondary Battery]

The lithium ion secondary battery of the present disclosure comprises, for example, a positive electrode, negative electrode, separator, non-aqueous electrolyte, terminal, and exterior body, which will be described below.

<Positive Electrode>

A positive electrode comprises, for example, a mixture layer, and a current collector.

(Mixture Layer in Positive Electrode)

A mixture layer comprises, for example, a positive electrode active material, conductive agent, binder, and solvent. The positive electrode active material is, for example, a compound such as LiCoO₂, LiNiO₂, LiMn₂O₄, LiFePO₄, LiCo_{1/3}Ni_{1/3}O₂, LiCo_{0.15}Ni_{0.8}Al_{0.05}O₂, LiNi_{0.5}Mn_{1.5}O₄. More preferably, examples of the positive electrode active material contain lithium composite oxide with Ni atomic ratio of which is 50% or more. The oxide is, for example, a cationic species included in the mixture layer as the positive electrode active material, excluding lithium, having a ratio of a number of nickel atoms which is 50% or more. Specifically, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, and LiCo_{0.15}Ni_{0.80}Al_{0.05}O₂ are applicable. In the present disclosure, a high energy density is cited as an aim. A high energy density can be achieved by increasing the battery capacity. When the ratio of the number of nickel atoms is 50% or more, a unit capacity of the material becomes greater. By using the aforementioned oxide, the amount of the mixture layer in the positive electrode is further decreased, and a thickness of the electrode is further thinned, and thus, a high energy density can be achieved.

For example, when graphite is used in the negative electrode active material and the oxide containing nickel is used in the positive electrode active material, a nickel ratio contained in the positive electrode active material causes less effect with respect to the energy density. This is, graphite containing lithium has substantially the same reduction potential as with lithium, because the graphite containing lithium has lowest potential in all materials. On the other hand, oxide potential changing depending on a difference of nickel amount in the positive electrode active material is approximately 0.1 V. Thus, when the graphite negative electrode is used, a discharge average voltage only changes within an approximate range of 4.3±0.05 V. In contrast, when the TNO negative electrode is used, the discharge average voltage changes within an approximate range of 2.8±0.05 V. Therefore, relatively, an influence caused by nickel ratio in the positive electrode active material cannot be ignored.

Furthermore, it is preferable that the ratio of the number of nickel atoms is 50% or more, because if the ratio of the number of nickel atoms is below 50%, it is difficult to obtain an effect of high capacity of the positive electrode side. Also, influence of an early loss of the effect of the present disclosure caused by collapse of active material particles through elution of manganese and aluminum contained in the positive electrode active material is considered. In the present disclosure, TNO is used as the negative electrode active material, ester and ether which cannot be used in conventional lithium ion batteries can be used as an non-aqueous electrolyte solvent; however, at the same time, such component has a high affinity with manganese ion and aluminum ion, thereby easily eluting as compared to an non-aqueous electrolyte with conventional carbonate alone. Although details are unknown, it is presumed that; in an electronegativity relationship between positive charge of manganese and aluminum and carbon, electrons used for covalent bonding are biased to an oxygen side, so that ester oxygen or ether oxygen charged δ⁻ is coordinated to form a complex. As a result, stability of manganese and aluminum in the non-aqueous electrolyte is increased.

Furthermore, the conductive agent used in the present disclosure is not specifically limited, and may be, for example, a publically-known or commercially available conductive agent carbon black such as acetylene black and ketjen black, carbon nanotube, carbon fiber, activated carbon, and graphite.

The binder is not specifically limited, and may be a publically-known or commercially available binder. For example, polyvinylidene fluoride (PVDF), polytetrafluoroethylene (PTFE), polyvinylpyrrolidone (PVP), polyvinyl chloride (PVC), polyethylene (PE), polypropylene (PP), ethylene-propylene copolymer, styrene-butadiene rubber (SBR), and acrylic resin can be used.

The solvent used in the present disclosure is not specifically limited, and the solvent can be selected from various types depending on the positive electrode active material or the binder used. Specifically, when PVDF is used as the binder, it is preferable that N-methyl-2-pyrrolidone is used as the solvent, while a rubber based binder such as styrene-butadiene rubber (SBR), polytetrafluoroethylene, polyvinyl alcohol, and carboxymethyl cellulose (CMC) is used, water is preferably used as the solvent.

(Current Collector)

The current collector used in the present disclosure is not specifically limited, however an aluminum foil is generally used as positive electrode current collector, and a porous aluminum current collector or the like may be used depending on the application.

The positive electrode can be prepared by the following method, for example. Initially, the positive electrode active material, conductive agent, binder, and the like are dispersed in a solvent to yield positive electrode slurry. Then, the positive electrode slurry is applied to one or both surfaces of the current collector, and then, the current collector is dried, for example, in vacuum in 80° C. to form a mixture layer on the current collector. Through the above steps, the positive electrode can be prepared.

Furthermore, in the above description, the positive electrode comprising the mixture layer and the current collector is explained. However, the present disclosure is not limited thereto, and if a half-cell structure is used instead of a full-cell structure, a metal lithium may be used as an opposite electrode instead of the positive electrode.

(Negative Electrode)

A negative electrode includes a mixture later and a current collector.

(Mixture Layer in Negative Electrode)

The mixture layer comprises a negative electrode active material, conductive agent, binder, and solvent. The negative electrode active material applicable in the present disclosure is niobium titanium oxide which is a monoclinic system Nb—Ti based composite oxide, and a high advantage is achieved when TiNb₂O₇ or Ti₂Nb₁₀O₂₉ is especially used.

Here, it is preferable that the content of niobium titanium oxide in the mixture layer is 80 to 95 mass %. Furthermore, it is preferable that an average secondary particle size of niobium titanium oxide used is 5 to 20 μm. Furthermore, the average secondary particle size in the present specification is a particle size with an integrated value of 50% in a particle size distribution obtained through a laser diffraction/dispersion method.

The conductive agent used in the present disclosure is not specifically limited, and may be a publically-known or commercially available conductive agent. The conductive agent may be, for example, carbon black such as acetylene black and ketjen black, carbon nanotube, carbon fiber, activated carbon, and graphite.

The binder is not specifically limited, and may be a publically-known or commercially available binder. For example, polyvinylidene fluoride (PVDF), polytetrafluoroethylene (PTFE), polyvinylpyrrolidone (PVP), polyvinyl chloride (PVC), polyethylene (PE), polypropylene (PP), ethylene-propylene copolymer, styrene-butadiene rubber (SBR), and acrylic resin can be used.

The solvent used for the binder in the present disclosure is not specifically limited, and the solvent can be selected from various types depending on the active material used or the binder used. Specifically, when PVDF is used as the binder, it is preferable that N-methyl-2-pyrrolidone is used as the solvent, while a rubber based binder such as styrene-butadiene rubber (SBR), polytetrafluoroethylene, polyvinyl alcohol, and carboxymethyl cellulose (CMC) is used. Water is preferably used as the solvent.

(Current Collector)

The current collector used in the present disclosure is not specifically limited, and an aluminum foil is generally used as a TNO negative electrode current collector, and a porous aluminum current collector or the like may be used depending on the use.

The negative electrode can be prepared by the following method, for example. Initially, niobium titanium oxide, conductive agent, binder, and the like are dispersed in a solvent to yield negative electrode slurry. Then, the negative electrode slurry is applied to one or both surfaces of the negative electrode current collector, and then, the negative electrode current collector is dried, for example, in vacuum in 80° C. to form a mixture layer on the current collector. Through the above steps, the negative electrode can be produced.

(Separator)

A separator interposed between the positive electrode and the negative electrode is, for example, a synthetic resin non-woven cloth or porous sheet formed of generally used polyolefin resin such as polyethylene (PE) and polypropylene (PP), and polytetrafluoroethylene (PTFE). The non-woven cloth and the porous sheet may have a single layer structure or a multi-layered structure.

(Non-Aqueous Electrolyte)

The non-aqueous electrolyte includes an electrolyte, non-aqueous solvent and aforementioned lithium alkoxysulfonate as additive of non-aqueous electrolyte, and the non-aqueous electrolyte usable for the lithium ion secondary battery of the present disclosure.

The electrolyte is not specifically limited, and it is preferable to use electrolyte salt containing lithium ion which is generally used in the lithium ion secondary battery. Lithium salt can be used, for example, LiBF₄ or LiPF₆. The electrolyte salt may be used combination of two or more electrolyte salts. Furthermore, concentration of electrolyte salt is not specifically limited, and may be approximately 0.3 to 3 M (mol/L) with respect to the non-aqueous solvent.

Specifically, the electrolyte salt which contains, for example, 0.5 to 3 M of LiPF₆ and/or LiBF₄ and excluding LiFSI, LiBOB, and LiPO₂F₂ can be used.

If the content of LiPF₆ and/or LiBF₄ is below 0.5 M, the amount of ion in the non-aqueous electrolyte becomes insufficient, and thus, a high output may not be achieved. Furthermore, if the content exceeds 3 M, viscosity of non-aqueous electrolyte becomes too high, penetration to the separator and resistance of the non-aqueous electrolyte become too high, and thus, a high output may not be achieved. Thus, it is preferable that the content is set to 0.5 to 3 M in consideration of the high output and the resistance of the non-aqueous electrolyte.

Furthermore, it is preferable that LiFSI, LiBOB, and LiPO₂F₂ not be contained as the electrolyte. These electrolytes are reductively decomposed in the negative electrode side in a charging time, and excessive SEI is formed, and thus, a high output which is an advantage of the present disclosure cannot be achieved. Although details are unknown, niobium in TNO which is the negative electrode active material in the present disclosure acts as a catalyst. Therefore the niobium specifically reacts and decomposes with carbonate, which is non-aqueous electrolyte component, to produce hydrofluoric acid.

In the present disclosure, a high output is mentioned as an aim, and to achieve the aim, the ion conductivity of non-aqueous electrolyte is an important parameter. Note that, the ion conductivity of the non-aqueous electrolyte will be described later, however, it is an approach from the non-aqueous solvent side, and parameters which influence the ion conductivity of non-aqueous electrolyte the most are a type and an amount of the electrolyte. Specifically, LiPF₆ and/or LiBF₄ have a large volume in anion, and an ion dissociation of excellent, and thus, a high output lithium ion battery can be structured. Furthermore, they do not affect TNO used as the negative electrode active material in the present disclosure, and thus, are suitable for the present disclosure.

The non-aqueous solvent can be used non-aqueous solvent applied in non-aqueous electrolyte system lithium ion secondary batteries.

It is preferable that the non-aqueous solvent contains a cyclic solvent and/or chain solvent. It is preferable that the cyclic solvent contains cyclic carbonate and/or cyclic ester, and the chain solvent contains chain carbonate and/or chain ether. The cyclic carbonate relates to a degree of dissociation of the non-aqueous electrolyte components, and the chain carbonate related to the viscosity of the non-aqueous electrolyte.

The cyclic carbonate has a high relative permittivity, and relates to improvement of lithium ion conductivity of the non-aqueous electrolyte. The Born equation indicative of solvation energy of ion species in the non-aqueous electrolyte includes a relative permittivity in the equation. When the relative permittivity increases, Gibbs' free energy tends to be greater in a negative. If the Gibbs' free energy is a negative, it means that the reaction spontaneously progresses. Furthermore, if the absolute value becomes greater, it means that the reaction further progresses. Thus, if cyclic carbonate is contained in the non-aqueous solvent, dissociation of cation components and anion components in the electrolyte is promoted, and thus, a ratio of the electrolyte present as ions in the non-aqueous solvent increases, thereby resulting in improvement of lithium ion conductivity.

Furthermore, the lithium ion conductivity is a parameter directly linked to rate characteristics of the battery, and thus, it is preferable that cyclic carbonate is included in the non-aqueous solvent. Furthermore, the chain carbonate relates to viscosity of the non-aqueous solvent. As mentioned above, the cyclic carbonate has a high relative permittivity, on the other hand, it has high viscosity in many cases. The viscosity of the non-aqueous solvent is directly linked to fluidity of the non-aqueous electrolyte, and relates to permeability of the non-aqueous electrolyte to the separator. If there is a location in which the non-aqueous electrolyte does not permeate to the separator, the location is not conductive, and thus, the battery cannot function its full performance, and the any battery performance is decreased. The chain carbonate can be used to prevent such a case, and the relative permittivity is not high but has low viscosity. As above, carbonate changes the role thereof in cyclic and chain forms, and thus, it is preferable that both are contained as the non-aqueous solvent for a better lithium ion battery. It is preferable that at least one of the aforementioned components be contained in the present disclosure.

Furthermore, γ-butyrolactone as cyclic ester is a compound with characteristics of both cyclic carbonate and ester. In general, γ-butyrolactone alone can be used in the lithium ion battery as non-aqueous solvent component. However, graphite is used as a negative electrode material in many cases, and in that case, γ-butyrolactone molecules enter between graphite layers, which may promote decomposition of graphite. Thus, γ-butyrolactone has not been used before. In the present disclosure, TNO which is used as the negative electrode active material does not have problems such as γ-butyrolactone entering between active material layers mentioned above, and thus, γ-butyrolactone can exert its full performance.

It is preferable that the cyclic carbonate is ethylene carbonate and/or propylene carbonate, and does not contain vinylene carbonate, fluoroethylene carbonate, vinylethylene carbonate.

The advantage of the present disclosure becomes higher when ethylene carbonate and propylene carbonate are used amongst cyclic carbonates. The ethylene carbonate has a very high relative permittivity in cyclic carbonates, and is an optimal material for maintaining high rate characteristics. Furthermore, propylene carbonate has substantially same characteristics as with ethylene carbonate; however, if graphite is used as the negative electrode active material, propylene carbonate may promote decomposition as in γ-butyrolactone by molecules entering between layers. Thus, it has not been used before. In the present disclosure, TNO used as the negative electrode active material does not have problems such as propylene carbonate entering between active materials layers mentioned above, and thus, propylene carbonate can exert its full performance.

Furthermore, in the present disclosure, it is preferable that the non-aqueous solvent does not contain vinylene carbonate, fluoroethylene carbonate, and vinylethylene carbonate. The reason relate the SEI formation unique due to TNO negative electrode, and if above carbonates are contained, overformation of SEI which could prevent conduction may possibly occur. As a result, a decrease in battery capacity and rate characteristics may possibly occur.

Furthermore, it is preferable that chain carbonate is at least one selected from the group consisting of dimethyl carbonate, ethyl methyl carbonate, and diethyl carbonate.

Chain carbonate is used for the purpose of lowering the viscosity of the non-aqueous electrolyte as explained above. Chain carbonate with a methyl group or an ethyl group has very low viscosity amongst chain carbonates, and thus, by using such chain carbonate, it is possible to fully exert high rate characteristics as an advantage of the present disclosure.

Furthermore, the non-aqueous electrolyte may contain 0.1 to 5 mass % of at least one selected from the group consisting of cyclic ether 1,3-dioxane, adiponitrile, and succinonitrile.

1,3-dioxane has advantages as non-aqueous solvent for a high output battery because of its lower viscosity than chain carbonate while exerting a high relative permittivity. However, 1,3-dioxane has a critical disadvantage in which oxidation decomposition potential is approximately 2.2 V which is approximately 1 V lower than chain carbonate, and becomes easily oxidation decomposition in the positive electrode side. Thus, it has not been used as non-aqueous solvent of a lithium ion battery. However, in the present disclosure, it does not adversely influence the battery performance if used in a range 0.1 to 5 mass %, and thus, a suitable amount of the above compound is contained as an non-aqueous electrolyte component to utilize its characteristics of lower viscosity than chain carbonate while exerting a high relative permittivity, in order to achieve the advantages of the present disclosure which are both high energy density and high output.

Furthermore, adiponitrile and succinonitrile are additives for improvement of safety and credibility. It is suitable that adiponitrile and succinonitrile are contained within the aforementioned range of mass % in the present disclosure. It is presumed that such compounds coordinate metal ions eluted from the current collector and the active materials to form a complex, and thus, the metal ion species of high activity is deactivated, and it is possible to suppress leaking current and gas generation. This leads to long-term continuation of the advantages of the present disclosure.

Specifically, in the present disclosure, as described above, lithium composite oxide with 50% or more Ni as atomic ratio can be contained in the mixture layer in the positive electrode, and from ionization tendency, nickel tends to elute amongst cationic species contained in the positive electrode active materials. In the present disclosure, dinitrile such as the adiponitrile and the succinonitrile contained in the non-aqueous electrolyte can be captured nickel ions generated in bulk when a overcharging in a form of complex, thereby preventing degradation of the battery. Thus, the advantages of the present disclosure which are both high energy density and high output can be maintained for a long period of time.

However, as 1,3-dioxane, adiponitrile, and succinonitrile have strong coordinating force, if the content thereof in the non-aqueous electrolyte becomes 5 mass % or more, ions required for charge/discharge may be captured, causing a decrease in the cycle characteristics, and thus, the range of 0.1 to 5 mass % is recommended.

Furthermore, sulfolane can be used as the non-aqueous solvent in addition to the cyclic carbonate and cyclic ester which are cyclic solvents. The chain ether of the chain solvent, for example, dimethoxyethane, dietoxyethane, and various glyme groups can be mixed with a main solvent for use.

The advantage of lithium alkoxysulfonate as additive of non-aqueous electrolyte is described as above. Such lithium alkoxysulfonate is, for example, at least one selected from the group consisting of lithium methoxysulfonate and lithium ethoxysulfonate. The additive is lithium methoxysulfonate alone, lithium ethoxysulfonate alone, or combination of lithium methoxysulfonate and lithium ethoxysulfonate. A total amount of all lithium alkoxysulfonates is based on the amount of the non-aqueous electrolyte, 0.5 to 2.0 mass %, or preferably, 1.0 to 2.0 mass %. A saturation concentration of lithium methoxysulfonate is 2.0 mass %, and if a total concentration of the additive is greater than 2.0 mass %, it is mixed with lithium ethoxysulfonate for use. A substance represented by RSOOO⁻Li⁺ where R is OCH₃, is lithium methoxysulfonate, and where R is OC₂H₅, is lithium ethoxysulfonate.

(Terminal)

The terminal is generally a metal. Material and shape thereof are not specifically limited, and in the present disclosure, aluminum and copper are suitable, and a shape which is not deformed by wire connection or the like is preferably suitable.

(Exterior Body)

The exterior body is, for example, a can material or a laminate material. Material and shape thereof are not specifically limited, and for example, stainless is suitable for a can material, and an aluminum foil with surface coating by plastic film is suitable for a laminate material. The shape can be changed depending on a cell capacity, and in general, when the cell capacity increases, the shape becomes larger.

The shape of the lithium ion secondary battery of the present disclosure is not specifically limited, and may be a coin type, button type, sheet type, laminated type, cylinder type, square type, and flat type, for example.

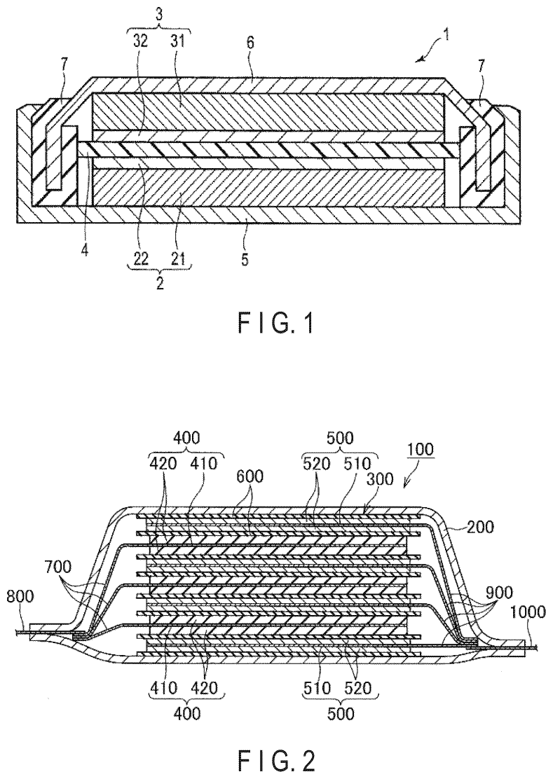

Hereinafter, the structure of the lithium ion secondary battery of the present disclosure will be explained with reference to the accompanying drawings, using a coin type lithium ion secondary battery as an example. FIG. 1 is a schematic cross-sectional view of a coin type battery, which is an example of the lithium ion secondary battery of the present application.

A coin type lithium ion secondary battery 1 includes a positive electrode 2, negative electrode 3, and a separator 4 located between the positive electrode 2 and the negative electrode 3. The positive electrode 2, negative electrode 3, and separator 4 are accommodated between a first external terminal 5 positioned in the lower part side and a second external terminal 6 positioned in the upper part side. A joint part of the first external terminal 5 and the second external terminal 6 is insulated by a gasket 7.

The positive electrode 2 includes a positive electrode current collector 21 positioned on the inner surface of the first external terminal 5 to be connected thereto, and a mixture layer 22 provided with a surface of the current collector 21 opposed to the separator 4. The negative electrode 3 includes a negative electrode current collector 31 positioned on the inner surface of the second external terminal 6 to be connected thereto, and a mixture layer 32 provided with a surface of the current collector 31 opposed to the separator 4. The separator 4 is impregnated in, for example, non-aqueous electrolyte. Ends of The second external terminal 6 are inserted into the first external terminal 5 while lower ends and both side surfaces of the ends are wrapped by the gasket 7, and an opening end of the first external terminal 5 in the lower part side is curved to the gasket 7 side such that the second external terminal 6 is fixed to the first external terminal 5 by caulking, and the joint part of the first external terminal 5 and the second external terminal 6 are insulated by the gasket 7.

Now, a layered type secondary battery which is an example of the lithium ion secondary battery of the present application will be explained with reference to FIG. 2.

The layered type lithium secondary battery includes a bag-like exterior body 200 formed of a laminate film. In the external body 200, an electrode group 300 of a layered structure is accommodated. The laminate film includes, for example, multiple (for example, two) plastic films with a metal foil such as aluminum foil interposed therebetween. One of the two plastic films is a heat fusion resin film. The exterior body 200 comprises the two laminate films overlaid such that the heat fusion resin film is opposed to one another, and the electrode group 300 is accommodated therein in an airtight manner by sealing the laminate film parts in the proximity of the electrode group 300 together by the heat fusion.

The electrode group 300 includes multiple positive electrodes 400, negative electrodes 500, and separators 600 interposed between the positive electrode 400 and the negative electrode 500 such that the negative electrode 500 is positioned in the outermost layer, and the separator 600 is positioned between the negative electrode 500 and the external body 200. The positive electrode 400 includes a positive electrode current collector 410 and mixture layers 420 formed on both surfaces of the current collector 410. The negative electrode 500 includes a negative electrode current collector 510 and mixture layers 520 formed on both surfaces of the current collector 510.

The positive electrode 400 includes a positive electrode lead 700 in which the current collector 410 extends from, for example, a left side surface of the mixture layer 420. Each positive electrode lead 700 is bundled in the external body 200 in the tip side, and is connected to each other. A positive electrode tab 800 has one end which is connected to the joint part of the positive electrode lead 700 and the other end extending outside through a sealing part of the exterior body 200. The negative electrode 500 includes a negative electrode lead 900 in which the current collector 510 extends from, for example, a right side surface of the mixture layer 520. Each negative electrode lead 900 is bundled in the external body 200 in the tip side, and is connected to each other. A negative electrode tab 1000 has one end connected to the joint part of the negative electrode lead 900 and the other end extending outside through the sealing part of the exterior body 200. Non-aqueous electrolyte is injected in the exterior body 200. The injection port of the exterior body 200 is sealed after the injection of the non-aqueous electrolyte.

### EXAMPLES

Now, examples are presented for further detailed description of the present disclosure. Note that the present disclosure is not limited to the following examples.

### Example 1-1

### (1) Preparation of Non-Aqueous Electrolyte

LiPF₆ was dissolved in a solution in which ethylene carbonate (EC) and dimethyl carbonate (DMC) are mixed in a volume ratio of 3 to 7, such that the concentration of LiPF₆ becomes 1.0 M. Then, 0.5 mass % of lithium methoxysulfonate was added with respect to the solution weight, and stirred for one hour by a magnetic stirrer to prepare the non-aqueous electrolyte of the present disclosure.

### (2) Manufacture of Test Cell

TiNb₂O₇ particles obtained from a hydrothermal synthesis, which is an active material, conductive agent, and binder were mixed with a solvent to prepare slurry. Acetylene black of Denka Company Ltd. was used as the conductive agent. KF polymer of Kureha Corporation was used as the binder. Mass ratio of the active material, conductive agent and binder is 85:10:5. N-methylpyrrolidone of Kanto Chemical Co., Inc. was used as the solvent. The slurry obtained was applied to one surface of an aluminum foil of 20 μm thickness by 50 g/m² basis weight. After the application, the negative electrode was obtained by pressing, punching by Φ13, and drying to evaporate the solvent.

One obtained negative electrode, one metal lithium of Φ14 as an opposite electrode, and one glass separator of Φ15 were put in a 2032 type coin cell exterior body such that the applied surface of the negative electrode and the metal lithium are opposed to each other with the separator interposed therebetween, and the prepared non-aqueous electrolyte was added. After an upper lid was applied to the exterior body, the periphery was caulked by a caulking machine to manufacture a test cell.

### (3) Charge/Discharge Test

Charge/discharge tests were performed by a Toyo System charge/discharge test apparatus (TOSCAT-3000). Measurement of discharge capacity was performed as follows. Initially, the manufactured test cell was charged at constant current/constant voltage of 0.1 ItA to 1.5 V, and was left for 15 minutes. Then, constant current discharge was performed at 0.1 ItA to 2.5 V to obtain a capacity of 252 mAh/g-active material. Then, the cell was charged at constant current/constant voltage of 0.1 ItA to 1.5 V and left for 15 minutes, and the discharge test was further performed at 5.0 ItA to obtain a capacity ratio of 89% vs 0.1 ItA. Here, “89% vs 0.1 ItA” indicates 5.0 ItA discharge capacity ratio with respect to 0.1 ItA, and the same applies to the following examples. In tables, an item of “5.0 ItA charge capacity ratio” indicates the results.

### Example 1-2

The test cell was manufactured and tested as in Example 1-1 except that lithium methoxysulfonate was not added in the non-aqueous electrolyte and 0.5 mass % of lithium ethoxysulfonate was added, and thereby, discharge capacity of 250 mAh/g-active material, and capacity ratio of 87% vs 0.1 ItA were obtained.

### Example 1-3

The test cell was manufactured and tested as in Example 1-1 except that lithium methoxysulfonate was not added in the non-aqueous electrolyte and 1.0 mass % of lithium ethoxysulfonate was added, and thereby, discharge capacity of 250 mAh/g-active material, and capacity ratio of 87% vs 0.1 ItA were obtained.

### Example 1-4

The test cell was manufactured and tested as in Example 1-1 except that lithium methoxysulfonate was not added in the non-aqueous electrolyte and 1.5 mass % of lithium ethoxysulfonate was added, and thereby, discharge capacity of 249 mAh/g-active material, and capacity ratio of 87% vs 0.1 ItA were obtained.

### Example 1-5

The test cell was manufactured and tested as in Example 1-1 except that 0.5 mass % of lithium methoxysulfonate was added in the non-aqueous electrolyte and 0.5 mass % of lithium ethoxysulfonate was added, and thereby, discharge capacity of 251 mAh/g-active material, and capacity ratio of 85% vs 0.1 ItA were obtained.

### Example 1-6

The test cell was manufactured and tested as in Example 1-5 except that 1.0 mass % of lithium ethoxysulfonate was added in the non-aqueous electrolyte, and thereby, discharge capacity of 249 mAh/g-active material, and capacity ratio of 91% vs 0.1 ItA were obtained.

### Example 1-7

The test cell was manufactured and tested as in Example 1-5 except that 0.2 mass % of lithium methoxysulfonate was added in the non-aqueous electrolyte and 0.3 mass % of lithium ethoxysulfonate was added, and thereby, discharge capacity of 248 mAh/g-active material, and capacity ratio of 88% vs 0.1 ItA were obtained.

### Example 1-8

The test cell was manufactured and tested as in Example 1-5 except that 1.5 mass % of lithium ethoxysulfonate was added in the non-aqueous electrolyte, and thereby, discharge capacity of 245 mAh/g-active material, and capacity ratio of 90% vs 0.1 ItA were obtained.

### Example 1-9

The test cell was manufactured and tested as in Example 1-5 except that 0.4 mass % of lithium methoxysulfonate was added in the non-aqueous electrolyte, and thereby, discharge capacity of 250 mAh/g-active material, and capacity ratio of 78% vs 0.1 ItA were obtained.

### Example 1-10

The test cell was manufactured and tested as in Example 1-5 except that lithium methoxysulfonate was not added in the non-aqueous electrolyte and 0.4 mass % of lithium ethoxysulfonate was added, and thereby, discharge capacity of 249 mAh/g-active material, and capacity ratio of 79% vs 0.1 ItA were obtained.

### Comparative Example 1

The test cell was manufactured and tested as in Example 1-1 except that an non-aqueous electrolyte without an additive of lithium methoxysulfonate is used, and thereby, discharge capacity of 247 mAh/g-active material, and capacity ratio of 70% vs 0.1 ItA were obtained.

### Conventional Example 1

The test cell was manufactured and tested as in Example 1-1 except that lithium titanate is used as negative electrode active material particle and an non-aqueous electrolyte without an additive of lithium methoxysulfonate is used, and thereby, discharge capacity of 150 mAh/g-active material, and capacity ratio of 99% vs 0.1 ItA were obtained.

Table 1 shows results of the charge/discharge tests of examples 1-1 to 1-10, comparison example 1, and conventional example 1. The discharge capacity at 0.1 ItA is approximately 1.7 times greater in the examples 1-1 to 1-10 and the comparative example 1 than the conventional example 1, and thus, it is understood that TNO active material used in the examples 1-1 to 1-10 and the comparative example 1 is advantageous in a high energy density of the lithium ion batteries. In the items of general evaluation of Table 1, cases where 0.1 ItA discharge capacity was higher than 240 mAh/g and a ratio of 0.1 ItA discharge capacity and 5.0 ItA discharge capacity was 80 or more were evaluated as double-circles (©), cases where 0.1 ItA discharge capacity was higher than 200 mAh/g and a ratio of 0.1 ItA discharge capacity and 5.0 ItA discharge capacity was 75 or more, although less than double-circles (©), were evaluated as circle (o), and other cases were evaluated as cross (x). Hereinafter, in items of general evaluation of other tables, similar evaluations are performed unless otherwise specified.

TABLE 1

| | Amount of | Amount of | | 5.0 ItA | |
|---|---|---|---|---|---|
| | additive of | additive of | 0.1 ItA | discharge | |
| | lithium | lithium | discharge | capacity | |
| | methoxysulfonate | ethoxysulfonate | capacity | ratio | General |
| | (wt. ) | (wt. %) | (mAh/g) | (%) | evaluation |
| Example 1-1 | 0.5 | — | 252 | 89 | ⊚ |
| Example 1-2 | — | 0.5 | 250 | 87 | ⊚ |
| Example 1-3 | — | 1.0 | 250 | 87 | ⊚ |
| Example 1-4 | — | 1.5 | 249 | 87 | ⊚ |
| Example 1-5 | 0.5 | 0.5 | 251 | 85 | ⊚ |
| Example 1-6 | 0.5 | 1.0 | 249 | 91 | ⊚ |
| Example 1-7 | 0.2 | 0.3 | 248 | 88 | ⊚ |
| Example 1-8 | 0.5 | 1.5 | 245 | 90 | ⊚ |
| Example 1-9 | 0.4 | — | 250 | 78 | ◯ |
| Example 1-10 | — | 0.4 | 249 | 79 | ◯ |
| Comparative | — | — | 247 | 70 | X |
| example 1 | | | | | |
| Conventional | — | — | 150 | 99 | X |
| example 1 | | | | | |

Examples 1-1 to 1-8 satisfy claims 1 and 2 of the present application. Compared to the conventional example 1, 0.1 ItA discharge capacity of examples 1-1 to 1-8 is greater than 0.1 ItA discharge capacity of the conventional example 1 by 95 mAh/g at minimum. Compared to the comparative example 1, 0.1 ItA discharge capacity of examples 1-1 to 1-8 is similar to that of the comparative example 1 while 5.0 ItA discharge capacity ratio is greater than 5.0 ItA discharge capacity ratio of comparative example 1 by 15% at minimum. The result proves the advantages of the present disclosure by which both output and energy density are achieved. Furthermore, example 1-9 and 1-10 are included in claim 1 but not in claim 2. 0.1 ItA discharge capacity of examples 1-9 and 1-10 is similar to that of the comparative example 1 while 5.0 discharge capacity ratio is improved in examples 1-9 and 1-10 than that of the comparative example 1 by 8% at minimum, and although it is less than examples 1-1 to 1-8, the advantages are acknowledgeable.

As above, the advantages of the present disclosure of achieving both output and energy density are acknowledged in all of the examples, and the advantages of the present disclosure are higher in the scope of claim 2.

Note that, if lithium methoxysulfonate alone is added by 2.0 M without adding lithium ethoxysulfonate, it is not dissolved, and thus, 0.5 M which is saturation concentration is used for the tests. If lithium ethoxysulfonate alone is added by 2.0 M without adding lithium methoxysulfonate, it is not dissolved, and thus, 1.5 M which is saturation concentration is used for the tests.

### Example 2-1

The test cell was manufactured and tested as in Example 1-1 except that propylene carbonate (PC) was used instead of ethylene carbonate in the non-aqueous electrolyte, and thereby, discharge capacity of 252 mAh/g-active material, and capacity ratio of 86% vs 0.1 ItA were obtained.

### Example 2-2

The test cell was manufactured and tested as in Example 1-1 except that solvent component in the non-aqueous electrolyte was γ-butyrolactone (GBL), and thereby, discharge capacity of 247 mAh/g-active material, and capacity ratio of 90% vs 0.1 ItA were obtained.

### Example 2-3

The test cell was manufactured and tested as in Example 1-1 except that γ-butyrolactone was used instead of ethylene carbonate in the non-aqueous electrolyte, and thereby, discharge capacity of 255 mAh/g-active material, and capacity ratio of 88% vs 0.1 ItA were obtained. Table 2 indicates results of examples 2-1 to 2-3.

### Example 2-4

The test cell was manufactured and tested as in Example 1-1 except that propylene carbonate was used instead of ethylene carbonate in the non-aqueous electrolyte and γ-butyrolactone was used instead of dimethyl carbonate in the non-aqueous electrolyte, and thereby, discharge capacity of 250 mAh/g-active material, and capacity ratio of 85% vs 0.1 ItA were obtained. Table 2 indicates results of examples 2-1 to 2-4.

TABLE 2

| | | | 5.0 ItA | |
|---|---|---|---|---|
| | | 0.1 ItA | discharge | |
| | | discharge | capacity | |
| | | capacity | ratio | General |
| | PC:GBL:DMC | (mAh/g) | (%) | evaluation |
| Example | 3:0:7 | 252 | 86 | ⊚ |
| 2-1 | | | | |
| Example | 0:10:0 | 247 | 90 | ⊚ |
| 2-2 | | | | |
| Example | 0:3:7 | 255 | 88 | ⊚ |
| 2-3 | | | | |
| Example | 3:7:0 | 250 | 85 | ⊚ |
| 2-4 | | | | |

In every level of examples 2-1 to 2-4, the advantages of the present disclosure of achieving both output and energy density are acknowledged. The non-aqueous solvent is liquid in a room temperature and viscosity is low in GBL and DMC, and thus, it is estimated that there was no adverse effect to the performance in the above structures.

### Example 3-1

The test cell was manufactured and tested as in Example 1-1 except that propylene carbonate is further added to the non-aqueous electrolyte and a volume ratio of ethylene carbonate, dimethyl carbonate, and propylene carbonate was set to 1.5:7:1.5, and thereby, discharge capacity of 245 mAh/g-active material, and capacity ratio of 88% vs 0.1 ItA were obtained. Table 3 indicates results of examples 3-1, 1-1, and 2-1.

TABLE 3

| | | | | 5.0 ItA | |
|---|---|---|---|---|---|
| | | | 0.1 ItA | discharge | |
| | | | discharge | capacity | |
| | | | capacity | ratio | General |
| | EC | PC | (mAh/g) | (%) | evaluation |
| Example 3-1 | With additive | With additive | 245 | 88 | ⊚ |
| Example 1-1 | With additive | Without additive | 252 | 89 | ⊚ |
| Example 2-1 | Without additive | With additive | 252 | 86 | ⊚ |

Example 3-1 is a system with two cyclic carbonates of EC and PC added to the non-aqueous electrolyte, and indicates the advantages of the present disclosure. EC is solid in a room temperature and dissolve at approximately 40° C. to be liquid of high viscosity, however, chain carbonate of low viscosity is contained in the present non-aqueous electrolyte, and thus, no problem was found in the above range of the present non-aqueous electrolyte structure.

### Example 4-1

The test cell was manufactured and tested as in Example 1-1 except that ethyl methyl carbonate (EMC) was used as chain carbonate in the non-aqueous electrolyte, and thereby, discharge capacity of 248 mAh/g-active material, and capacity ratio of 90% vs 0.1 ItA were obtained.

### Example 4-2

The test cell was manufactured and tested as in Example 1-1 except that diethyl carbonate (DEC) was used as chain carbonate in the non-aqueous electrolyte, and thereby, discharge capacity of 248 mAh/g-active material, and capacity ratio of 88% vs 0.1 ItA were obtained.

### Example 4-3

The test cell was manufactured and tested as in Example 1-1 except that dimethyl carbonate and ethyl methyl carbonate of the same amount were used as chain carbonate in the non-aqueous electrolyte, and thereby, discharge capacity of 253 mAh/g-active material, and capacity ratio of 90% vs 0.1 ItA were obtained.

### Example 4-4

The test cell was manufactured and tested as in Example 1-1 except that dimethyl carbonate and diethyl carbonate of the same amount were used as chain carbonate in the non-aqueous electrolyte, and thereby, discharge capacity of 251 mAh/g-active material, and capacity ratio of 87% vs 0.1 ItA were obtained.

### Example 4-5

The test cell was manufactured and tested as in Example 1-1 except that ethyl methyl carbonate and diethyl carbonate of the same amount were used as chain carbonate in the non-aqueous electrolyte, and thereby, discharge capacity of 247 mAh/g-active material, and capacity ratio of 85% vs 0.1 ItA were obtained. Table 4 indicates results of examples 4-1 to 4-5 and 1-1.

TABLE 4

| | | 0.1 ItA | 5.0 ItA | |
|---|---|---|---|---|
| | | discharge | discharge | |
| | | capacity | capacity | General |
| | EC:DMC:EMC:DEC | (mAh/g) | ratio | evaluation |
| Example 4-1 | 3:0:7:0 | 248 | 90 | ⊚ |
| Example 1-1 | 3:7:0:0 | 252 | 89 | ⊚ |
| Example 4-2 | 3:0:0:7 | 248 | 88 | ⊚ |
| Example4-3 | 3:3.5:3.5:0 | 253 | 90 | ⊚ |
| Example4-4 | 3:3.5:0:3.5 | 251 | 87 | ⊚ |
| Example4-5 | 3:0:3.5:3.5 | 247 | 85 | ⊚ |

In every level of examples 4-1 to 4-5, the advantages of the present disclosure of achieving both output and energy density are acknowledged. It is presumed that there were no problems even in the above structures because the non-aqueous electrolyte solvent is liquid in a room temperature and viscosity is low except for EC.

### Example 5-1

The test cell was manufactured and tested as in Example 1-1 except that 0.1 weight % of 1,3-dioxane (1,3-DO) was added with respect to 100 weight % of non-aqueous electrolyte, and thereby, discharge capacity of 252 mAh/g-active material, and capacity ratio of 90% vs 0.1 ItA were obtained.

### Example 5-2

The test cell was manufactured and tested as in Example 1-1 except that 2.5 weight % of 1,3-dioxane was added with respect to 100 weight % of non-aqueous electrolyte, and thereby, discharge capacity of 250 mAh/g-active material, and capacity ratio of 92% vs 0.1 ItA were obtained.

### Example 5-3

The test cell was manufactured and tested as in Example 1-1 except that 5.0 weight % of 1,3-dioxane was added with respect to 100 weight % of non-aqueous electrolyte, and thereby, discharge capacity of 246 mAh/g-active material, and capacity ratio of 92% vs 0.1 ItA were obtained.

### Example 5-4

The test cell was manufactured and tested as in Example 1-1 except that 0.1 weight % of adiponitrile (AZN) was added with respect to 100 weight % of non-aqueous electrolyte, and thereby, discharge capacity of 254 mAh/g-active material, and capacity ratio of 90% vs 0.1 ItA were obtained.

### Example 5-5

The test cell was manufactured and tested as in Example 1-1 except that 2.5 weight % of adiponitrile was added with respect to 100 weight % of non-aqueous electrolyte, and thereby, discharge capacity of 249 mAh/g-active material, and capacity ratio of 88% vs 0.1 ItA were obtained.

### Example 5-6

The test cell was manufactured and tested as in Example 1-1 except that 5.0 weight % of adiponitrile was added with respect to 100 weight % of non-aqueous electrolyte, and thereby, discharge capacity of 242 mAh/g-active material, and capacity ratio of 87% vs 0.1 ItA were obtained.

### Example 5-7

The test cell was manufactured and tested as in Example 1-1 except that 0.1 weight % of succinonitrile (SCN) was added with respect to 100 weight % of non-aqueous electrolyte, and thereby, discharge capacity of 252 mAh/g-active material, and capacity ratio of 90% vs 0.1 ItA were obtained.

### Example 5-8

The test cell was manufactured and tested as in Example 1-1 except that 2.5 weight % of succinonitrile was added with respect to 100 weight % of non-aqueous electrolyte, and thereby, discharge capacity of 250 mAh/g-active material, and capacity ratio of 88% vs 0.1 ItA were obtained.

### Example 5-9

The test cell was manufactured and tested as in Example 1-1 except that 5.0 weight % of succinonitrile was added with respect to 100 weight % of non-aqueous electrolyte, and thereby, discharge capacity of 243 mAh/g-active material, and capacity ratio of 90% vs 0.1 ItA were obtained.

### Example 5-10

The test cell was manufactured and tested as in Example 1-1 except that 6.0 weight % of 1,3-dioxane was added with respect to 100 weight % of non-aqueous electrolyte, and thereby, discharge capacity of 215 mAh/g-active material, and capacity ratio of 92% vs 0.1 ItA were obtained.

### Example 5-11

The test cell was manufactured and tested as in Example 1-1 except that 6.0 weight % of adiponitrile was added with respect to 100 weight % of non-aqueous electrolyte, and thereby, discharge capacity of 213 mAh/g-active material, and capacity ratio of 92% vs 0.1 ItA were obtained.

### Example 5-12

The test cell was manufactured and tested as in Example 1-1 except that 6.0 weight % of succinonitrile was added with respect to 100 weight % of non-aqueous electrolyte, and thereby, discharge capacity of 210 mAh/g-active material, and capacity ratio of 92% vs 0.1 ItA were obtained.

### Example 5-13

The test cell was manufactured and tested as in Example 1-1 except that 0.08 weight % of 1,3-dioxane was added with respect to 100 weight % of non-aqueous electrolyte, and thereby, discharge capacity of 239 mAh/g-active material, and capacity ratio of 85% vs 0.1 ItA were obtained.

### Example 5-14

The test cell was manufactured and tested as in Example 1-1 except that 1.0 weight % of 1,3-dioxane and 1.0 weight % of adiponitrile were added with respect to 100 weight % of non-aqueous electrolyte, and thereby, discharge capacity of 247 mAh/g-active material, and capacity ratio of 86% vs 0.1 ItA were obtained.

### Example 5-15

The test cell was manufactured and tested as in Example 1-1 except that 0.08 weight % of 1,3-dioxane and 1.0 weight % of succinonitrile were added with respect to 100 weight % of non-aqueous electrolyte, and thereby, discharge capacity of 250 mAh/g-active material, and capacity ratio of 87% vs 0.1 ItA were obtained.

### Example 5-16

The test cell was manufactured and tested as in Example 1-1 except that 1.0 weight % of adiponitrile and 1.0 weight % of succinonitrile were added with respect to 100 weight % of non-aqueous electrolyte, and thereby, discharge capacity of 248 mAh/g-active material, and capacity ratio of 86% vs 0.1 ItA were obtained. Table 5 indicates results of examples 5-1 to 5-16.

TABLE 5

| | | | | 0.1 ItA | 5.0 ItA | |
|---|---|---|---|---|---|---|
| | | | | dis- | discharge | |
| | | | | charge | capacity | General |
| | 1,3-DO | AZN | SCN | capacity | ratio | eval- |
| | (wt. %) | (wt. %) | (wt. %) | (mAh/g) | (%) | uation |
| Example 5-1 | 0.1 | — | — | 252 | 90 | ⊚ |
| Example 5-2 | 2.5 | — | — | 250 | 92 | ⊚ |
| Example 5-3 | 5.0 | — | — | 246 | 92 | ⊚ |
| Example 5-4 | — | 0.1 | — | 254 | 90 | ⊚ |
| Example 5-5 | — | 2.5 | — | 249 | 88 | ⊚ |
| Example 5-6 | — | 5.0 | — | 242 | 87 | ⊚ |
| Example 5-7 | — | — | 0.1 | 252 | 90 | ⊚ |
| Example 5-8 | — | — | 2.5 | 250 | 88 | ⊚ |
| Example 5-9 | — | — | 5.0 | 243 | 90 | ⊚ |
| Example 5-10 | 6.0 | — | — | 215 | 92 | ◯ |
| Example 5-11 | — | 6.0 | — | 213 | 92 | ◯ |
| Example 5-12 | — | — | 6.0 | 210 | 92 | ◯ |
| Example 5-13 | 0.08 | — | — | 239 | 85 | ◯ |
| Example 5-14 | 1.0 | 1.0 | — | 247 | 86 | ⊚ |
| Example 5-15 | — | 1.0 | 1.0 | 250 | 87 | ⊚ |
| Example 5-16 | 1.0 | — | 1.0 | 248 | 86 | ⊚ |

In every level of examples 5-1 to 5-9 and 5-14 to 5-16, the advantages of the present disclosure of achieving both output and energy density are acknowledged. 1,3-dioxane is considered to exert a high relative permittivity, and adiponitrile and succinonitrile are considered to aid the improvement of safety and credibility. Furthermore, in examples 5-10 to 5-13 where the additive amount is greater than 5.0 weight % or below 0.1 weight %, 0.1 ItA discharge capacity is higher than 200 mAh/g and a ratio of 0.1 ItA discharge capacity and 5.0 ItA discharge capacity is 75 or more. As above, it is understood that, when 1,3-dioxane, adiponitrile, and succinonitrile are each added by 0.1 to 5 mass %, good battery characteristics are obtainable.

### Comparative Example 6-1

The test cell was manufactured and tested as in Example 1-1 except that electrolytes are not added to the non-aqueous electrolyte, and thereby, discharge capacity of 0 mAh/g-active material, and capacity ratio of 0% vs 0.1 ItA were obtained.

### Example 6-1

The test cell was manufactured and tested as in Example 1-1 except that a concentration of electrolytes is set to 0.5 M, and thereby, discharge capacity of 250 mAh/g-active material, and capacity ratio of 82% vs 0.1 ItA were obtained.

### Example 6-2

The test cell was manufactured and tested as in Example 1-1 except that a concentration of electrolytes is set to 1.5 M, and thereby, discharge capacity of 252 mAh/g-active material, and capacity ratio of 86% vs 0.1 ItA were obtained.

### Example 6-3

The test cell was manufactured and tested as in Example 1-1 except that a concentration of electrolytes is set to 3.0 M, and thereby, discharge capacity of 253 mAh/g-active material, and capacity ratio of 83% vs 0.1 ItA were obtained.

### Example 6-4

The test cell was manufactured and tested as in Example 1-1 except that a concentration of electrolytes is set to 4.0 M, and thereby, discharge capacity of 246 mAh/g-active material, and capacity ratio of 75% vs 0.1 ItA were obtained.

### Example 6-5

The test cell was manufactured and tested as in Example 1-1 except that lithium tetrafluoroborate is used in electrolytes and a concentration thereof is set to 0.5 M, and thereby, discharge capacity of 245 mAh/g-active material, and capacity ratio of 82% vs 0.1 ItA were obtained.

### Example 6-6

The test cell was manufactured and tested as in Example 1-1 except that lithium tetrafluoroborate is used in electrolytes and a concentration thereof is set to 1.5 M, and thereby, discharge capacity of 248 mAh/g-active material, and capacity ratio of 86% vs 0.1 ItA were obtained.

### Example 6-7

The test cell was manufactured and tested as in Example 1-1 except that lithium tetrafluoroborate is used in electrolytes and a concentration thereof is set to 3.0 M, and thereby, discharge capacity of 249 mAh/g-active material, and capacity ratio of 83% vs 0.1 ItA were obtained.

### Example 6-8

The test cell was manufactured and tested as in Example 1-1 except that lithium tetrafluoroborate is used in electrolytes and a concentration thereof is set to 4.0 M, and thereby, discharge capacity of 242 mAh/g-active material, and capacity ratio of 75% vs 0.1 ItA were obtained.

### Example 6-9

The test cell was manufactured and tested as in Example 1-1 except that LiFSI is used in electrolytes and a concentration thereof is set to 1.5 M, and thereby, discharge capacity of 246 mAh/g-active material, and capacity ratio of 75% vs 0.1 ItA were obtained.

### Example 6-10

The test cell was manufactured and tested as in Example 1-1 except that LiBOB is used in electrolytes and a concentration thereof is set to 1.5 M, and thereby, discharge capacity of 248 mAh/g-active material, and capacity ratio of 75% vs 0.1 ItA were obtained.

### Example 6-11

The test cell was manufactured and tested as in Example 1-1 except that LiPF₂O₂ is used in electrolytes and a concentration thereof is set to 1.5 M, and thereby, discharge capacity of 246 mAh/g-active material, and capacity ratio of 75% vs 0.1 ItA were obtained. Table 6 indicates results of Examples 6-1 to 6-11 and Comparative example 6-1.

TABLE 6

| | | | | 5.0 ItA | |
|---|---|---|---|---|---|
| | | | 0.1 ItA | discharge | |
| | | Amount of | discharge | capacity | |
| | Type of | electrolytes | capacity | ratio | General |
| | electrolytes | (M) | (mAh/g) | (%) | evaluation |
| Comparative | — | 0 | 0 | 0 | X |
| example 6-1 | | | | | |
| Example 6-1 | LiPF₆ | 0.5 | 250 | 82 | ⊚ |
| Example 6-2 | LiPF₆ | 1.5 | 252 | 86 | ⊚ |
| Example 6-3 | LiPF₆ | 3.0 | 253 | 83 | ⊚ |
| Example 6-4 | LiPF₆ | 4.0 | 246 | 75 | ◯ |
| Example 6-5 | LiBF₄ | 0.5 | 245 | 82 | ⊚ |
| Example 6-6 | LiBF₄ | 1.5 | 248 | 86 | ⊚ |
| Example 6-7 | LiBF₄ | 3.0 | 249 | 83 | ⊚ |
| Example 6-8 | LiBF₄ | 4.0 | 242 | 75 | ◯ |
| Example 6-9 | LiFSI | 1.5 | 246 | 75 | ◯ |
| Example 6-10 | LiBOB | 1.5 | 248 | 75 | ◯ |
| Example 6-11 | LFO | 1.5 | 246 | 75 | ◯ |

In every level of examples 6-1 to 6-3 and 6-5 to 6-7, the advantages of the present disclosure of achieving both output and energy density are acknowledged. However, as in examples 6-4 and 6-8, if an additive is added above 3 M, the resistance of non-aqueous electrolyte increases, and 5.0 ItA discharge capacity ratio becomes slightly poor. The concentration is set properly since the amount of electrolyte additive is excessive, the viscosity of non-aqueous electrolyte increases, which adversely affects discharge rate. Furthermore, when LiFSI, LiBOB, and LFO are added, it is not as effective as LiPF₆ and LiBF₄, and 5.0 ItA discharge capacity ratio becomes slightly poor. Note that, the comparative example 6-1 does not contain electrolytes, and thus, it does not function as a battery.

As above, it is understood that adding of 0.5 to 3.0 M of LiPF₆ or LiBF₄ can achieve good battery characteristics.

### Example 7-1

The metal lithium opposite electrode was changed to a positive electrode contained LiNi_{0.5}Co_{0.2}Mn_{0.3}O₂ (NCM) as an active material, and the coin cell type was changed to 1 Ah laminate cell type. Specifically, a positive electrode with positive electrode current collector leads and a negative electrode with negative electrode current collector leads were alternately layered on a separator connected thereto in a zigzag manner to obtain an electrode element. The separator had a base layer of polyethylene and surface layers of polypropylene on both surfaces of the base layer (PE/PP/PE). The thickness of the separator was 20 μm. Then, the positive electrode leads and the negative electrode leads were each bundled, and a positive electrode terminal was connected to the bundled positive electrode leads by ultrasonic welding and a negative electrode terminal was connected to the bundled negative electrode leads by ultrasonic welding. The obtained electrode element had a thickness of 4.8 mm, and 1 Ah of rated capacity. Note that, the “rated capacity” in this example indicates discharge capacity measured when constant current-constant voltage charging was performed at upper limit voltage of 4.2 V and current value of 0.5 C (cutoff current 0.05 C), and then constant current discharge was performed at lower limit voltage of 2.7 V and current value of 0.2 C.

Then, as an exterior body, two laminate films having a structure in which a heat fusion resin layer of polyolefin, metal layer of aluminum foil, and protection layer of nylon resin and polyester resin were layered in this order were prepared. The two laminated films were overlaid together such as the heat fusion resin layers are opposed to each other and adhesive surfaces of the laminated films match each other to accommodate an electrode group in two accommodating concave portions therein. Between peripheral edges of the two laminated films, the electrode group was arranged such that a portion where the heat fusion resin part of each terminal is formed passes therethrough, and each terminal partially exposed to the outside. In this state, at three sides of the laminate films having the two sides from which each tab extends, the heat fusion resin layers in the peripheral edges of the laminate films were fused. Then, the non-aqueous electrolyte prepared as above was injected from one unfused side of the exterior body. Then, in a decompressed environment, the one side of the exterior body was fused, and a test cell was manufactured.

The test cell was tested as in Example 1-1, and thereby, discharge capacity of 1012 mAh/g, discharge average voltage of 2.35 V, and capacity ratio of 89% vs 0.1 ItA were obtained.

### Example 7-2

The test cell was manufactured and tested as in Example 7-1 except that LiNi_{0.6}Co_{0.2}Mn_{0.2}O₂ is used as the positive electrode, and thereby, discharge capacity of 1020 mAh/g, discharge average voltage of 2.34 V, and capacity ratio of 92% vs 0.1 ItA were obtained.

### Example 7-3

The test cell was manufactured and tested as in Example 7-1 except that LiNi_{0.8}Co_{0.1} Mn_{0.1}O₂ is used as the positive electrode active material, and thereby, discharge capacity of 999 mAh/g, discharge average voltage of 2.38 V, and capacity ratio of 89% vs 0.1 ItA were obtained.

### Example 7-4

The test cell was manufactured and tested as in Example 7-1 except that LiNi_{0.5}Mn_{0.5}O₂ is used as the positive electrode active material, and thereby, discharge capacity of 1010 mAh/g, discharge average voltage of 3.00 V, and capacity ratio of 80% vs 0.1 ItA were obtained.

### Example 7-5

The test cell was manufactured and tested as in Example 7-1 except that LiNiO₂ is used as the positive electrode active material, and thereby, discharge capacity of 996 mAh/g, discharge average voltage of 2.44 V, and capacity ratio of 85% vs 0.1 ItA were obtained.

### Example 7-6

The test cell was manufactured and tested as in Example 7-1 except that LiNi_{0.33}Co_{0.33}Mn_{0.33}O₂ is used as the positive electrode active material, and thereby, discharge capacity of 950 mAh/g, discharge average voltage of 2.37 V, and capacity ratio of 92% vs 0.1 ItA were obtained. Table 7 indicates results of example 7-1 to 7-6. In the items of general evaluation of Table 7, cases where a ratio of 0.1 ItA discharge capacity and 5.0 ItA discharge capacity was 75 or more and 0.1 ItA discharge capacity was higher than 950 mAh/g were evaluated as double-circles (⊚), cases where 0.1 ItA discharge capacity was higher than 900 mAh/g, although less than double-circles (⊚), were evaluated as circle (∘), and cases where 0.1 ItA discharge capacity was lower than 900 mAh/g were evaluated as cross (x).

TABLE 7

| | | | Dis- | 0.1 ItA | 5.0 ItA | |
|---|---|---|---|---|---|---|
| | | | charge | dis- | discharge | Gen- |
| | NCM | | average | charge | capacity | eral |
| | Ni:Co: | | voltage | capacity | ratio | eval- |
| | Mn | Others | (V) | (mAh/g) | (%) | uation |
| Example 7-1 | 5:2:3 | — | 2.35 | 1012 | 89 | ⊚ |
| Example 7-2 | 6:2:2 | — | 2.34 | 1020 | 92 | ⊚ |
| Example 7-3 | 8:1:1 | — | 2.38 | 999 | 89 | ⊚ |
| Example 7-4 | — | LNMO | 3.00 | 1010 | 80 | ⊚ |
| Example 7-5 | — | LiNiO₂ | 2.24 | 996 | 85 | ⊚ |
| Example 7-6 | 3:3:3 | — | 2.37 | 950 | 92 | ◯ |

In every level of examples 7-1 to 7-6, the advantages of the present disclosure of achieving both output and energy density are acknowledged. However, if a ratio of nickel in the positive electrode active material is lowered to 0.333, the discharge capacity is decreased, and the energy density cannot be secured. Thus, the ratio of nickel requires to be greater than 0.333.

In the present disclosure, achieving both output and energy density characteristics of a lithium ion battery is aimed, and when TNO is used as the negative electrode active material and lithium methoxysulfonate and lithium ethoxysulfonate are added as the additive of non-aqueous electrolyte by 0.5 to 2.0 weight %, the above characteristics are achieved. The advantage cannot be achieved by TNO alone or the additives alone, and thus, the present disclosure is based on a unique effect by the aforementioned combination. The output is not equal to a case where lithium titanate is used for the negative electrode active material; however, a difference is approximately 10%, and considering approximately 1.7 times higher discharge capacity by TNO in the present disclosure, the superior battery structure is obvious.

### INDUSTRIAL APPLICABILITY

As can be understood from the above, the present application presents the battery which can achieve both output and energy density characteristics by using niobium lithium titanate as the negative electrode active material, and lithium methoxysulfonate and lithium ethoxysulfonate as the additives of non-aqueous electrolyte, and the battery are expected to be used in various fields including mobility applications as electric vehicles and drones, and natural energy storage, and the like.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lithium ion secondary battery comprising:
a negative electrode comprising a mixture layer which contains a niobium titanium oxide as a negative electrode active material; and
non-aqueous electrolyte containing lithium alkoxysulfonate represented by RSOOO⁻Li⁺, where R is at least one selected from the group consisting of OCH₃ and OC₂H₅.

2. The lithium ion secondary battery of claim 1, wherein a content of the lithium alkoxysulfonate in the non-aqueous electrolyte is 0.5 to 2.0 mass %.

3. The lithium ion secondary battery of claim 1, wherein the non-aqueous electrolyte contains at least one selected from the group consisting of cyclic carbonate, chain carbonate, and γ-butyrolactone as non-aqueous solvent.

4. The lithium ion secondary battery of claim 3, wherein the cyclic carbonate is ethylene carbonate and/or propylene carbonate, and does not contain vinylene carbonate, fluoroethylene carbonate, and vinylethylene carbonate.

5. The lithium ion secondary battery of claim 3, wherein the chain carbonate is at least one selected from the group consisting of dimethyl carbonate, ethyl methyl carbonate, and diethyl carbonate.

6. The lithium ion secondary battery of claim 1, wherein the non-aqueous electrolyte contains 0.1 to 5 weight % of at least one selected from the group consisting of cyclic ethers of 1,3-dioxane, adiponitrile, and succinonitrile.

7. The lithium ion secondary battery of claim 1, wherein the non-aqueous electrolyte contains 0.5 to 3 M of LiPF₆ and/or LiBF₄ as an electrolyte, and does not contain LiFSi, LiBOB, and LiPO₂F₂.

8. The lithium ion secondary battery of claim 1, further comprising a positive electrode, the positive electrode comprising a mixture layer which contains a lithium composite oxide with an atomic ratio of 50% or more of Ni.

9. The lithium ion secondary battery of claim 8, wherein the lithium composite oxide is at least one selected from the group consisting of LiNi_{0.5}Co_{0.2}Mn_{0.3}O₂, LiNi_{0.6}Co_{0.2}Mn_{0.2}O₂, and LiNi_{0.8}Co_{0.1}Mn_{0.1}O₂.

10. A non-aqueous electrolyte used in the lithium ion secondary battery of claim 1.
